(19) United States
(12) Patent Application Publication
(10) Pub. No.: US 2002/0161897 A1
(43) Pub. Date: Oct. 31, 2002

(54) IP connection communication system and IP connection terminal

(76) Inventor: Nobuyoshi Yamamoto, Saitama (JP)

Correspondence Address: GREENBLUM & BERNSTEIN, P.L.C., 1941 ROLAND CLARKE PLACE, RESTON, VA, 20191, US

(21) Appl. No.: 09/988,622

(22) Filed: Nov. 20, 2001

(30) Foreign Application Priority Data
Apr. 26, 2001 (JP) 2001-128977

(51) Int. Cl. G06F 15/16

(52) U.S. Cl. 709/227

(57) ABSTRACT

An IP connection system for establishing communication between each of IP connection terminals assigned with a global IP address on every connection to an internet, in which a global IP address (G_{A}-G_{D}) is registered to the directory service server (4) corresponding to the calling code (Y_{A}-Y_{D}) of the IP connection terminal (3A-3D) as a receiving side when it is connected to the internet, and the global IP address (G_{B}) corresponding to the calling code (Y_{B}) of the receiving IP connection terminal (3B) is notified to the sending IP connection terminal (3A) to the sending IP connection terminal (3A) when the sending IP connection terminal (3A) inquires the calling code (Y_{B}) thereby enabling to establish communication from the sending side to the receiving side.

### BACKGROUND OF THE INVENTION

1. Field of the Invention

The present invention concerns an IP connection system for establishing communication between each of IP connection terminals with one of the IP connection terminals as a receiving terminal, the terminal being assigned with a global IP address by a provider on every connection to an internet, as well as an IP connection terminal used for such a communication system, and it is particularly suitable for use in the communication system of wireless IP telephone.

2. Related Art Statement

Heretofore, an internet telephone using voice signal transmission protocol (VoIP) has been proposed so far. Usual internet telephone intends to utilize internet circuits in the line from usual sending telephone to receiving telephone.

Specifically, a public telephone network is used for connecting an usual sending telephone and a local access point thereof and for connecting a usual receiving telephone and a local access point thereof, and an internet circuit is used for connecting between each of the access points. Thus, based on the usual local public telephone circuit rate, for example, of 10 yen/3 min, a user can call telephone at a uniform rate all over the country by paying each unit rate of 10 yen/3 min regarding each of the two terminals, that is, 20 yen/3 min in total.

By the way, a handy type portable computer referred to as a notebook personal computer or a personal digital assistance (PDA) can be utilized as a portable wireless communication equipment by merely inserting a LAN card and, if a wireless LAN access point connected to an internet circuit is available, the terminal can be connected to the internet by way of the access point.

Accordingly, assuming that the PDA on the sending side and the PDA on the receiving side are always connected to the internet, it is theoretically possible to establish communication between them with no requirement of paying charges for the public telephone circuit at all.

However, communication between the two computers (IP connection terminals) by way of the internet can not be established unless the global IP address to which the destination computer is connected is known.

That is, excepting for the case where the destination computer has already acquired a fixed IP address, a global IP address is usually assigned temporarily by a provider at the instance the connection is established with the provider, so that the global IP address changes on every connection.

Accordingly, when communication is undertaken between computers connected to the internet, since the global IP address of the destination computer can not be known, it is actually impossible to establish the communication.

Now, in some restaurants, cafes or hotels, a service has been started recently of locating a wireless LAN access point connected to the internet circuit and lending a LAN card to a customer, so that a portable computer such as a PDA or note personal computer carried by the customer can be connected to the internet circuit.

When the portable computer is connected by way of the wireless LAN access point to the internet circuit, a global IP address is assigned to the computer and the communication can be established with the portable computer being as a receiving terminal. However, it is actually impossible to establish communication also in this case since a sender can not recognize the global IP address of this portable computer.

### OBJECT OF THE INVENTION

In view of the above, it is an technique subject of the present invention to enable reliable communication with a destination IP connection terminal connected to the internet and assigned with a global IP address.

### SUMMARY OF THE INVENTION

For solving the subject described above, the present invention provides an IP connection communication system for establishing communication between each of IP connection terminals with an IP connection terminal assigned with a global IP address by a provider on every connection to an internet as a receiving terminal, the system comprising;

(A) a user registration means for registration of machine authentication data inherent to an IP connection terminal owned by a user and a calling code correspondingly to a directory service server connected to the internet,

(B) waiting registration request means for sending a waiting request packet comprising a machine authentication data and a global IP address assigned by a provided from the OP connection terminal to the directory service server when other IP connection terminal as a receiving terminal is connected to the internet (the waiting registration is a registered state of a terminal ready for receiving and waiting for communication),

(C) a waiting registration means for reading the machine authentication data and the global IP address from a packet when the directory server receives the waiting request packet from the sending IP connection terminal and registering the global IP address corresponding to the machine authentication data and the calling code thereof as the current connection address in a predetermined memory area,

(D) a destination address request means for sending a sending request packet demanding for the notification of a global IP address corresponding to the calling code of the receiving IP connection terminal,

(E) an IP address notification means for sending back the global IP address corresponding to the calling code of the receiving IP connection terminal recorded in the packet to the sending IP connection terminal when the directory service server receives the sending request packet from the sending IF connection terminal, and

(F) a connection request means for sending the connection request packet to the global IP address from the sending IP connection terminal in accordance with TCP/IP when the global IP address corresponding to the calling code of the receiving terminal is sent back.

According to the present invention, user registration is at first conducted for an IP connection terminal owned by a user who undertakes to get the service from a directory service server connected to an internet, by registering a machine authentication data inherent to the terminal and a calling code correspondingly.

When the IP connection terminal for which the user registration has been completed is connected to the internet and assigned with a global IP address by a provider, a waiting request packet comprising the machine authentication data and the global IP address is sent to the directory service server.

On receiving the waiting request packet from the IP connection terminal, the directory service server reads the machine authentication data and the global IP address from the packet and registers the global IP address corresponding to the machine authentication data and the calling code as a current connection address in a predetermined memory area.

Then, when one of IP connection terminals intends to call to other terminal, a sending request packet demanding for the notification of the global IP address corresponding to the calling code of the receiving IP connection terminal is sent from the sending IP connection terminal to the directory service server.

On receiving the sending request packet from the sending IP connection terminal, the directory service server retrieves the current global IP address corresponding to the calling code of the receiving IP connection terminal recorded in the packet and sending the same back to the sending IP connection terminal.

Thus, since the sending IP connection terminal can recognize the global IP address corresponding to the receiving calling code, communication can be established by sending the connection request packet to the global IP address in accordance with procedures specified by TCP/IP.

In a case where the system is adapted to incorporate the machine authentication data inherent to the IP connection terminal in the third layer data of the waiting request packet and to conduct the sending request packet and the waiting registration or IP address notification by the directory service server on the condition that the machine authentication data agrees with the previously registered user's machine authentication data, only the previously registered regular user can receive the service of the IP connection communication system according to the present invention.

Then, in a case where either one (or both) of the IP connection terminals is (or are) a wireless terminal used by attaching a LAN card to be connected in a wireless fashion to an wireless LAN access point connected to an internet, when the system is adapted to incorporate, in the LAN card, an MAC address encrypted under a certain rule or the MAC address per se, since the MAC address is a unique code present solely in the world, reliability of the authentication whether the user is an regular user or not is improved.

Further, as has been described above, the IP connection terminal is not restricted only to the portable computer but may be a desk top type computer, so long as it has a user registration request means, a waiting registration means and a calling means and, further, it is not restricted only to the type connected to the internet in a wireless fashion but may be of a wire-connected type.

Then, the calling means includes a calling code input means for inputting the calling code for the other IP connection terminal, a destination address request means for sending a request packet demanding for the notification of a global IP address registered as a current connection address of the inputted calling code inputted by the calling code input means, and a connection request means for sending the connection request packet to the global IP address when the global IP address of the other IP connection terminal is sent back from the directory service server in compliance with the demand of the request packet in accordance with TCP/IP.

According to this constitution, since the global IP address to which the receiving IP connection terminal is connected can be available from the directory service server, communication with the receiving IP connection terminal can be established by usual procedures specified in TCP/IP.

### DESCRIPTION OF THE ACCOMPANYING DRAWINGS

FIG. 1 is a schematic explanatory view showing the entire constitution of an IP connection communication system according to the present invention:

FIG. 2 is an explanatory view showing an example of an IP connection terminal used for the system;

FIG. 3 is a flow chart showing a user registration request means;

FIG. 4 is a flow chart showing a waiting registration request means;

FIG. 5 is a flow chart showing a destination address request means;

FIG. 6 is a flow chart showing a user registration means;

FIG. 7 is a flow chart showing a waiting registration means;

FIG. 8 is a flow chart showing an IP address notification means;

FIG. 9 is a conceptional view showing a user registration procedure;

FIG. 10 is a conceptional view showing a waiting registration procedure;

FIG. 11 is a conceptional view showing a calling procedure.

### DESCRIPTION OF PREFERRED EMBODIMENTS

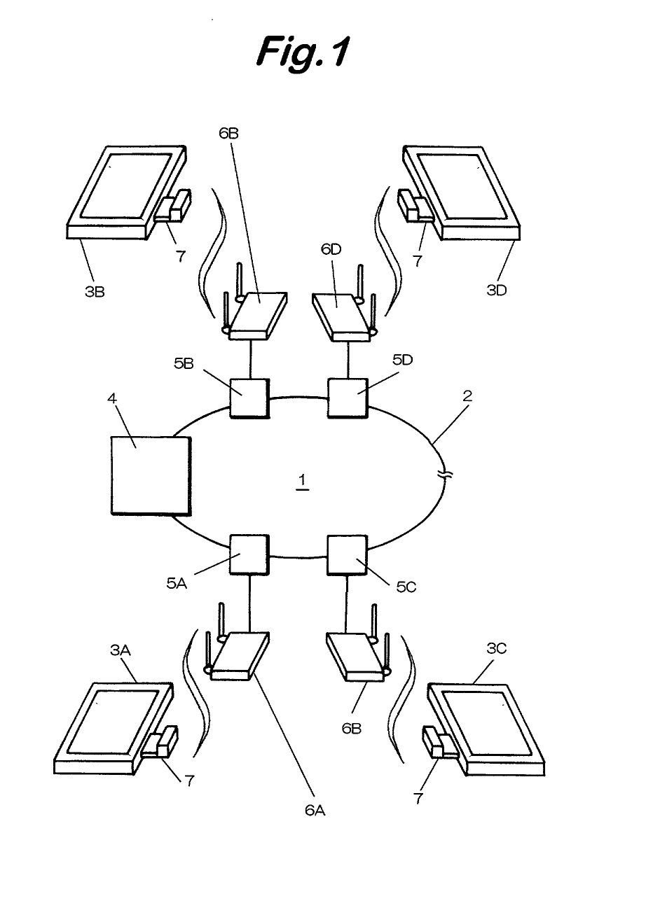

An IP connection communication system shown in FIG. 1 is used for establishing communication between each of IP connection terminals 3A to 3D connected to an internet 2 either by way of a wired or wireless fashion. For each of the IP connection terminals 3A to 3D, a desk top type, notebook type, handy type or any other appropriate type computer can be used.

A directory service server 4 is located on the internet 2 on every IP connection terminals 3A to 3D for registering each calling code Y and a global IP address G as the connection address thereof and notifying the global IP address G when demanded.

In this embodiment, a handy type computer is used for each of the IP connection terminals 3A to 3D as sending and receiving devices which are assigned with non-fixed global IP addresses G by providers 5A to 5D.

Each of the IP connection terminals 3A to 3D is mounted with a LAN card 7 connected in a wireless fashion to each of wireless LAN access points 6A to 6D connected to the internet 2 and each of the wireless LAN access points 6A to 6D is open-set, that is, not restricting the type of terminal equipments connected thereto.

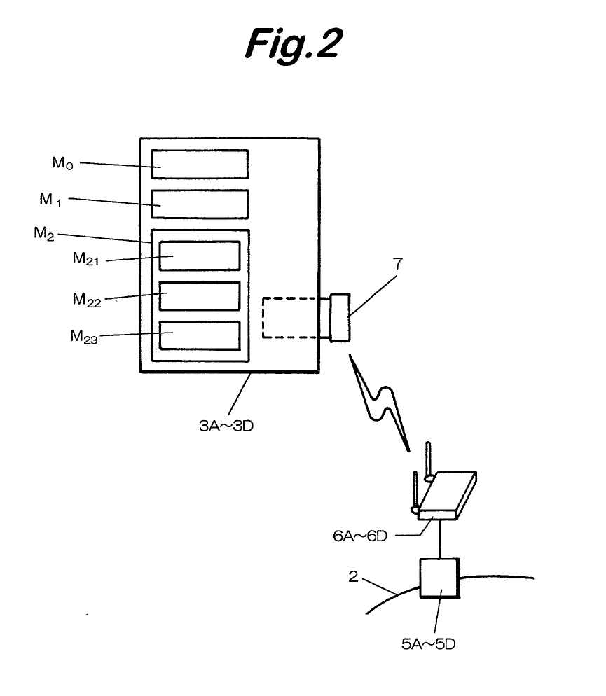

Further, each IP connection terminal (3A-3D) has, as shown in FIG. 2, a user registration request means M₀, a waiting registration request means M₁ and a calling means M₂ for calling other IP connection terminal 3. Each means (M₀-M₂) is set up by installing a communication program commercially available usually as an accessory to the LAN card 7.

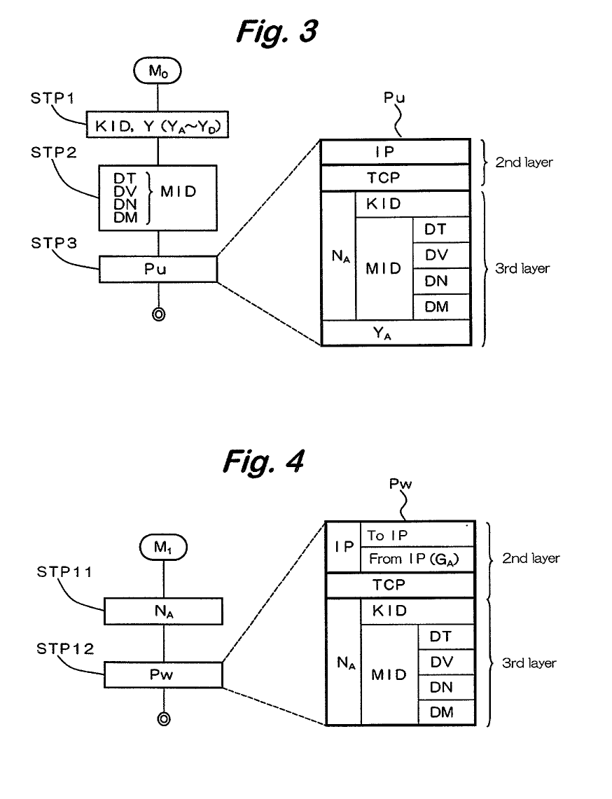

The user registration request means M₀ inputs an individual identification data KID having user's name and password and a calling code Y (Y_{A}-Y_{D}) having a digital sequence like a telephone number and stores each of the data KID and Y to a predetermined memory area at step STP1 as shown in FIG. 3.

Then, at the next step STP2, it reads MAC address DM set in the LAN card 7, to generate machine identification data MID inherent to the equipment having the time data DT upon installing a communication program, version information DV, random number DN and the MAC address DM and stores the machine identification data MID to a predetermined memory area.

Then, at the next step STP3, it generates a user registration request packet Pu having the machine authentication data N (N_{A}-N_{D}) comprising the individual identification data KID and the machine identification data MID, and the calling code Y, and sends the packet to the directory service server 4.

Further, at STP11, after turning ON of the power source of the IP connection terminal 3, the waiting registration request means M₁ reads the machine authentication data N of its own on every time to generate a waiting request packet Pw at step STP12 and sends the same in accordance with TCP/IP protocol to the directory service server 4.

The waiting request packet Pw contains, in a third layer data, a customer identification data KID for specifying a user and a machine identification data MID for specifying the IP connection terminal thereof as the machine authentication data N_{A}.

In this case, when wireless LAN access points 6A to 6D connected to the internet 2 are present near the IP connection terminals 3A to 3D, respectively, connection with one of providers 5A to 5D to which the access points 6A to 6D are connected, connection is established at first with one of the provides 5A to 5D to which access points 6A to 6D are connected, and the global IP address (G_{A}-G_{D}) is assigned by one of the providers (5A-5D), so that the global IP address (G_{A}-G_{D}) thereof is automatically written in the IP address of the waiting request packet Pw.

Referring to the case of calling other IP connection terminal 3B from the IP connection terminal 3A, the calling means M₂ has a calling code input means M₂₁, a destination address request means M₂₂ for sending a sending request packet Ps demanding for the notification of a global IP address G_{B} corresponding to the calling code Y_{B} inputted by the calling input means M₂₁ to the directory service server 4, and a connection request means M₂₃ for sending a connection request packet Pc to the global address G_{B} in accordance with TCP/IP when the global IP address G_{B} of other IP connection terminal is sent back from the directory service server 4 in accordance with the demand of the sending request packet Ps.

The calling means M₂ starts its execution upon booting the communication program and, as shown in FIG. 5, displays a push button screen on a display of the IP connection terminal 3A at step STP21, and inputs calling at step STP22 upon pressing of the button with a finger or a touch pen at step STP22 and records the number as a destination calling code Y_{B} at the STP23.

Then, it reads the machine authentication data N_{A} of its own and the destination calling code Y_{B} at step STP24, to generate a sending request packet Ps at step STP25 and sends the same to the directory service server 4 to demand the notification of the global IP address G_{B} as a current destination connection of the IP connection terminal 3B assigned with the calling code Y_{B}.

The sending request packet Ps contains the customer identification data KID for specifying the user and the machine identification data MID for specifying the IP connection terminal in the third layer data as the machine authentication data N_{A} and has the calling code Y_{B} recorded therein.

Then, the calling means M₂ stands-by till the global IP address G_{B} corresponding to the calling code Y_{B} is sent back from the directory service server 4 at step 26, then goes to step STP27 at the instance the global IP address G_{B} is notified and sends a connection request packet Ps to the destination global IP address G_{B} in accordance with usual TCP/IP protocol.

The steps STP21-23 are for calling code input means M₂₁, the steps STP24-25 are for destination address request means M₂₂ and the steps STP26-27 are for connection request means M₂₃.

The directory service server 4 has a user registration means M₃ for registering a user upon receiving the user registration request packet Pu from the IP connection terminal (3A-3D), a waiting registration means M₄ for conducting waiting registration upon receiving the waiting request packet Pw from the IP connection terminal (3A-3D), and an IP address notification means M₅ for sending back the destination global IP address G_{B} to the sending IP connection terminal (3A-3D) upon receiving the sending request packet Ps from the IP connection terminal (3A-3D).

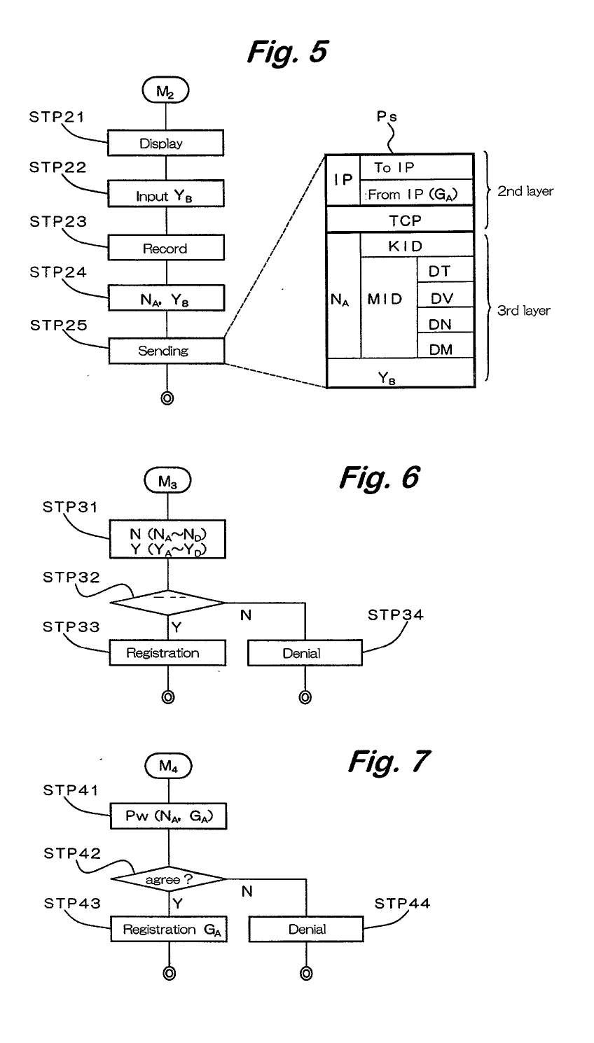

As shown in FIG. 6, the user registration means M₃ reads the machine authentication data (N_{A}-N_{D}) comprising the individual identification data KID and the machine identification data MID, and the calling code (Y_{A}-Y_{D}) from the user registration request packet Pu at step STP31 and judges whether the MAC address DM and the version information DV contained in the machine identification data MID are regular or not at step STP32. When they are judged normal, it registers the machine authentication data (N_{A}-N_{D}) and the calling code (Y_{A}-Y_{D}) correspondingly at step STP33. If they are judged not regular, it denies the user registration at step STP34.

As shown in FIG. 7, the waiting registration means M₄ reads the machine authentication data (N_{A}-N_{D}) and the global IP address (G_{A}-G_{D}) from the waiting request packet Pw at step STP41 and judges whether the machine authentication data (N_{A}-N_{D}) agrees with the previously registered users machine authentication data or not at step STP42. When they are judged to agree, it registers the global IP address (G_{A}-G_{D}) corresponding to the machine authentication data (N_{A}-N_{D}) as the current destination connection in a predetermined memory area at step STP43. If they do not agree, it denies the waiting registration at step STP44.

In the waiting registration, the data is updated and registered on every reception of the waiting request packet Pw.

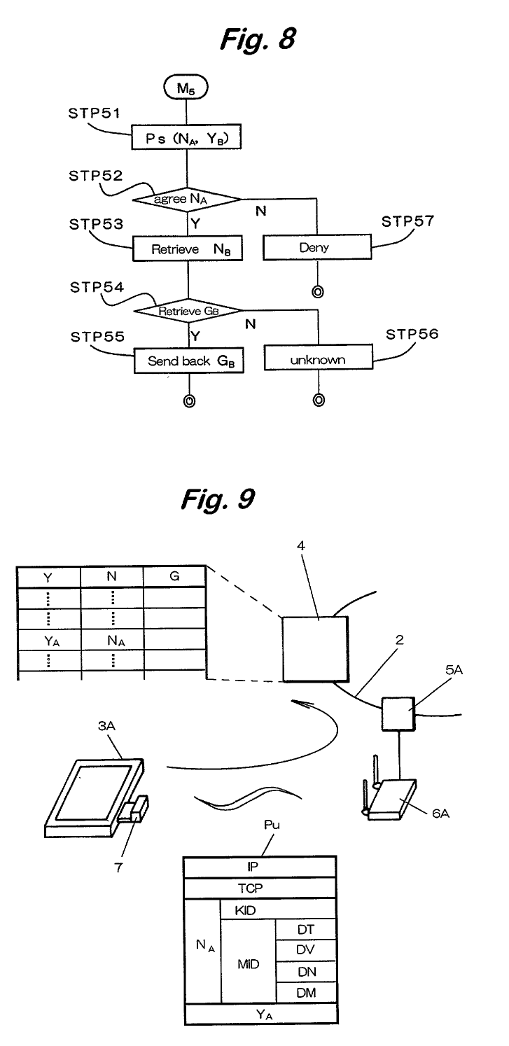

As shown in FIG. 8, the IP address notification means M₅ reads the machine authentication data N_{A} and the destination calling code Y_{B} from the sending request packet Ps at step STP51, judges at step STP52 whether the machine authentication data N_{A} agrees with the previously registered user's machine authentication data or not and, when they agree, it retrieves the machine authentication data N_{B} corresponding to the calling code Y_{B} at step STP53 and goes to step STP54. If they do not agree, it goes to step STP57.

At step STP54, when the global IP address G_{B} as the current connection address of the machine authentication data N_{B} is registered, the process goes to the step STP55 and sends back the destination global IP address G_{B} to the sending IP connection terminal (3A-3D) and, if not registered, it sends back the data to the effect that the connection address is unknown at step STP56. Further, it sends data of denying the notification of the destination global IP address at step STP57.

The example of the constitution of the present invention is as has been described above and the operation thereof is to be explained.

When a user possessing the IP connection terminal (3A-3D) intends to conduct communication by way of the IP connection communication system according to the present invention as shown in FIG. 9, the user sends a user registration request packet Pu to the directory service server 4. Then, the server 4 reads necessary data out of the packet Pu and conducts user registration by registering the machine authentication data (N_{A}-N_{D}) inherent to the IP connection terminal (3A-3D) owned by the user and the calling code (Y_{A}-Y_{D}) correspondingly.

When registration has been completed, sending/receiving are enabled between each of the IP connection terminal 3A to 3D wherever the access point (6A-6D) for wireless LAN is located.

As actual procedures, when the switch for the IP connection terminal (3A-3D) is turned ON at first, waiting registration is conducted automatically.

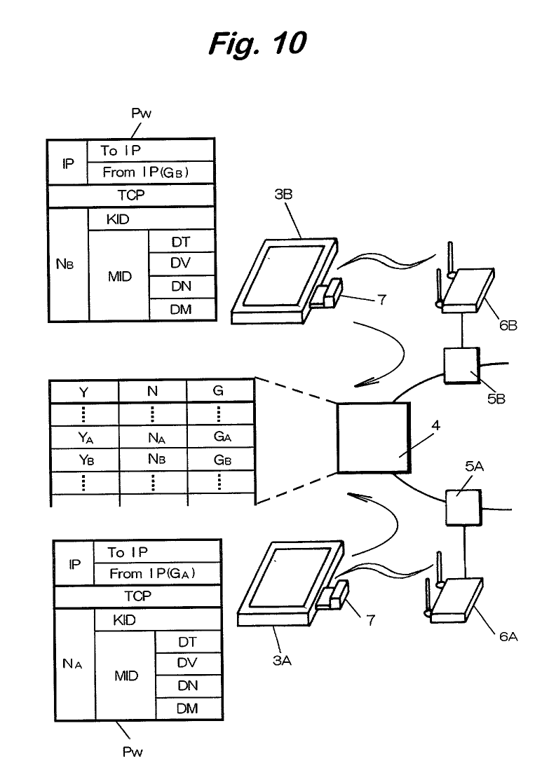

In the waiting registration, as shown in FIG. 10, the waiting request packet Pw is sent to the directory service server 4. The server reads the machine authentication data (N_{A}-N_{D}) and the global IP address (G_{A}-G_{D}) assigned by the provider (5A-5D) connected at present and, when it is judged to be a registered user based on the machine authentication data (N_{A}-N_{D}), it registers the global IP address (G_{A}-G_{D}) as the connection address corresponding to the machine authentication data N and the calling code Y.

That is, in a state where the IP connection terminal (3A-3D) is connected to the internet 2, the global IP address (G_{A}-G_{D}) as the connection address is registered corresponding to each machine authentication data (N_{A}-N_{D}) and calling code (Y_{A}-Y_{D}) to the directory service server 4, to enter a state waiting for communication.

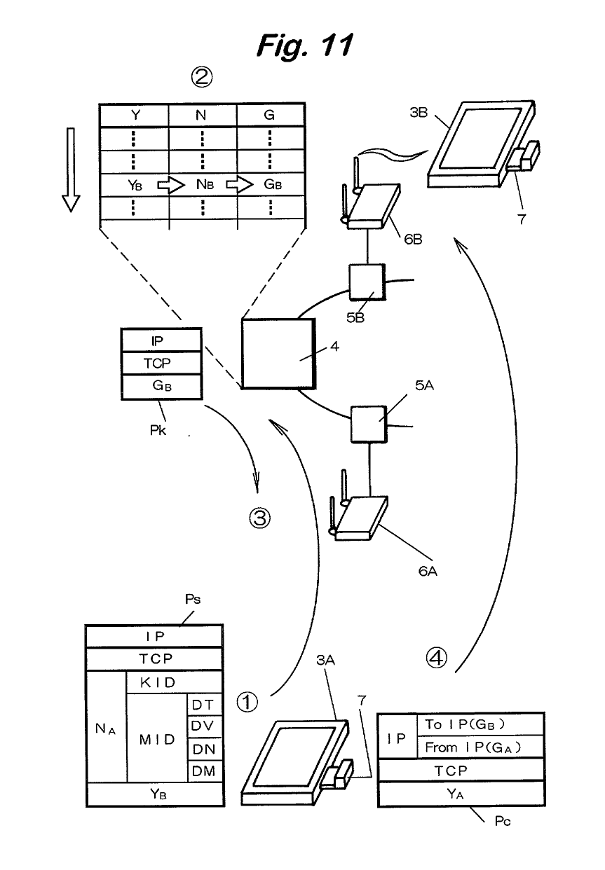

In this state, when IP connection terminal 3A intends to establish communication with other IP connection terminal 3B, it is connected in accordance with the calling procedures shown in FIG. 11.

At first, when a calling code Y_{B} corresponding to the connection terminal 3B is inputted, a request packet Ps having the machine authentication data of the use and the calling code Y_{B} as the destination is sent to the directory service server 4 (refer to \mathring{1}).

The directory service server 4 reads the machine authentication data N and the calling code Y_{B} from the sending request packet Ps. When it is judged to be a regular user based on the machine authentication data N, the server retrieves a global IP address G_{B} connected with the IP connection terminal corresponding to the destination calling code Y_{B} (refer to \mathring{2}) and, when it is found, sends a notification packet Pk containing the recorded global IP address G_{B} back to the sending IP connection terminal 3A (refer to \mathring{3}).

When the notification packet Pk is sent back, the sending IP connection terminal 3A reads out a global IP address G_{B} corresponding to the destination calling code Y_{B} and can sent the connection request packet Pc to the destination global IP address G_{B} in accordance with usual TCP/IP protocol (refer to \mathring{4}).

Accordingly, when the destination IP connection terminal 3B is connected by way of a wireless LAN access point (6A-6D) to the internet, communication can be established.

As described above according to the present invention, since communication can be established between each of the portable type IP wireless terminals 3A-3D connected to the internet, the system can be used for sending and receiving usual data, as well as can be used as a portable telephone or television telephone for sending and receiving voice data or image data.

In addition, wherever the wireless LAN access points 6A-6D are located, or so long as the connection terminals 3A-3D are connected to the internet 2 even if the wireless LAN access points 6A-6D are not present, a data communication system not requiring charges for the public telephone circuits when calling telephone not only throughout Japan but also all over the world can be constructed.

For example, when the wireless LAN access points 6A to 6D are located, for example, in convenience stores, supermarkets or fast food stores, the system can be used as a communication system for sending POS data or stock data of the stores to a head office for centralized management but also it can provide a service of connecting the IP connection terminals 3A to 3D such as computers carried by customers to the internet 2.

As has been described above according the present invention, since the global IP address is registered in the directory service server corresponding to the calling code of each of the IP connection terminals connected to the internet and assigned with a provider, the user can receive the notification for the global IP address as the current connection address by referring the calling code of the destination IP connection terminal to the directory service server. Accordingly, this can provide an excellent effect capable of establishing communication between each of the IP connection terminals in accordance with TCP/IP communication protocol even in a case where the global IP address is changed on every connection to the internet.

What is claimed is;

1. An IP connection communication system for establishing communication between each of IP connection terminals 3A-3D, in which an IP connection terminal (3A-3D) is assigned with a global IP address (G) by a provider (5A-5D) on every connection to an internet (2) as a receiving terminal, the system comprising;
a user registration means (M₃) for registration of machine authentication data (N_{A}-N_{D}) inherent to the IP connection terminal (3A-3D) owned by a user and a calling code (Y_{A}-Y_{D}) correspondingly to a directory service server (4) connected to the internet (2),
a waiting registration request means (M₁) for sending a waiting request packet Pw comprising a machine authentication data (N_{A}-N_{D}) and a global IP address (G_{A}-G_{D}) assigned by the provided (5A-5D) from the CP connection terminal (3A-3D) to the directory service server (4) when the IP connection terminal (3A-3D) as the receiving terminal is connected to the internet,
a waiting registration means (M₄) for reading out the machine authentication data (N_{A}-N_{D}) and the global IP address (G_{A}-G_{D}) from the packet (Pw) when the directory server (4) receives the waiting request packet (Pw) from the IP connection terminal (3A-3D) and registering the global IP address (G_{A}-G_{D}) as the current connection address in a predetermined memory area corresponding to the machine authentication data (N_{A}-N_{D}) and the calling code (Y_{A}-Y_{D}) thereof,
a destination address request means (M₂) for sending a sending request packet (Ps) demanding for the notification of a global IP address (G_{B}) corresponding to the calling code (Y_{B}) of the receiving IP connection terminal (3B),
an IP address notification means (M₅) for sending back the global IP address (G_{B}) corresponding to the calling code (Y_{B}) of the receiving IP connection terminal (3B) recorded in the packet Ps to the sending IP connection terminal (3A) when the directory service server (4) receives the sending request packet Ps from the IP connection terminal (3A), and
a connection request means (M₂) for sending the connection request packet to the global IP address (G_{B}) from the sending IP connection terminal (3A) in accordance with TCP/IP when a global IP address (G_{B}) corresponding to the calling code (Y_{B}) on the receiving side is sent back.

2. An IP connection communication system for establishing communication between each of IP connection terminals 3A-3D, in which an IP connection terminal (3A-3D) is assigned with a global IP address (G) by a provider (5A-5D) on every connection to an internet (2) as a receiving terminal, the system comprising;
a user registration means (M₃) for registration of machine authentication data (N_{A}-N_{D}) inherent to the IP connection terminal (3A-3D) owned by a user and a calling code (Y_{A}-Y_{D}) correspondingly to a directory service server (4) connected to the internet (2),
a waiting registration means (M₄) for reading the machine authentication data (N_{A}-N_{D}) and the global IP address (G_{A}-G_{D}) from a packet Pw upon receiving a waiting request packet (Pw) comprising the machine authentication data (N_{A}-N_{D}) and the global data assigned by the provider from the receiving IP connection terminal (3A-3D), and registering the global IP address (G_{A}-G_{D}) as the current connection address in a predetermined memory area corresponding to the machine authentication data (N_{A}-N_{D}) and the calling code (Y_{A}-Y_{D}) thereof, and
an IP address notification means (M₅) for sending back the global IP address (G_{B}) corresponding to the calling code (Y_{B}) of the receiving IP connection terminal (3B) recorded in the packet Ps to the sending IP connection terminal (3A) when the directory service server (4) receives the sending request packet Ps from the IP connection terminal (3A).

3. An IP connection communication system as defined in claim 1 or 2, wherein a third layer data of the waiting request packet (Pw) and the sending request packet (Ps) contains a customer identification data KID for specifying a user and a machine identification data MID for specifying the IP connection terminal (3A-3D) thereof as the machine authentication data N_{A}-N_{D}, and
the waiting registration means (M₄) and the IP address notification means (M₅) of the directory service server (4) are executed when the machine authentication data (N_{A}-N_{D}) agrees with a previously registered user's machine authentication data (N_{A}-N_{D}).

4. An IP connection communication system as defined in claim 3, wherein
a LAN card (7) connected in a wireless fashion with each of wireless LAN access points 6A to 6D connected to the internet is attached to each IP connection terminal (3A-3D) and
an MAC address (DM) encrypted under a predetermined rule or the MAC address (DM) per se of the LAN card (7) is contained in the machine identification data (MID).

5. An IP connection terminal for establishing communication with other IP connection terminal (3B-3D) assigned with a global IP address (G_{B}-G_{D}) by a provider (5B-5D) on every connection to an internet (2) in accordance with TCP/IP, the terminal comprising;
a waiting registration request means (M₁) for sending a waiting request packet (Pw) comprising the authentication data (N_{A}) and the global IP address (G_{A}) assigned by the provider (5A) to a directory service server (4) in which the calling code (Y_{A}) corresponding to the machine authentication data (N_{A}) are previously stored and demanding for registration of the global IP address (G_{A}) corresponding to the machine authentication data (N_{A}) and the calling data (Y_{A}) as the current connection address and
a calling means (M₂) for calling other IP connection terminal (3B-3D) in which the calling means (M₂) comprises;
a calling code input means (M₂₁) for inputting a calling code (Y_{B}-Y_{D}) of other IP connection terminal (3B-3D),
a destination address request means (M₂₂) for sending a sending request packet (Ps) demanding for the notification of the global IP address (G_{B}-G_{D}) corresponding to the calling code (Y_{B}-Y_{D}) inputted by the calling code input means (M₂₁) to the directory service server (4),
a connection request means for sending a connection request packet (Pc) to the global IP address (G_{B}-G_{D}) in accordance with TPC/IP when the global IP address (G_{B}-G_{D}) as the destination of other IP connection terminal (3B-3D) is sent back from the directory service server (4) in accordance with the demand for the sending request packet (Ps).

6. An IP connection terminal for establishing communication with other IP connection terminal (3B-3D) assigned with a global IP address (G_{B}-G_{D}) by a provider (5B-5D) on every connection to an internet (2) in accordance with TCP/IP, the terminal comprising;
a calling code input means (M₂₁) for inputting a calling code (Y_{B}-Y_{D}) of other IP connection terminal (3B-3D),
a destination address request means (M₂₂) for sending a sending request packet (Ps) demanding for the notification of a global IP address (G_{B}-G_{D}) corresponding to the calling code (Y_{B}-Y_{D}) inputted by the calling code input means (M₂₁) to the directory service server (4), and
a connection request means for sending a connection request packet (Pc) to the global IP address (G_{B}-G_{D}) in accordance with TPC/IP when the global IP address (G_{B}-G_{D}) as the connection address of other IP connection terminal (3B-3D) is sent back from the directory service server (4) in accordance with the demand for the sending request packet (Ps).

7. An IP connection terminal assigned with a global IP address (G_{A}-G_{D}) by a provider (5A-5D) on every connection to a internet (2) upon communication by way of the internet (2) in accordance with TCP/IP, the terminal comprising
a waiting registration request means (M₁) for sending a waiting request packet (Pw) comprising a machine authentication data (N_{A}-N_{D}) and a global IP address (G_{A}-G_{D}) assigned by a provider (5A-5D) to a directory service server (4) in which a calling code (Y_{A}-Y_{D}) corresponding to the machine authentication data (N_{A}-N_{D}) is previously registered upon connection to the internet (2) and demanding for the registration of the global IP address (G_{A}-G_{D}) corresponding to the machine authentication data (N_{A}-N_{D}) and calling data (Y_{A}-Y_{D}) as current connection address.

8. An IP connection terminal as defined in claim 5, 6 or 7, wherein
a LAN card (7) connected in a wireless to a wireless LAN access point (6A-6D) is connected to the internet (2), the third layer data of the waiting request packet Pw and the sending request packet Ps contains the customer identification data (KID) for specifying the user and a machine identification data (MID) for specifying the IP connection terminal thereof as the machine authentication data (NA-ND), and the machine identification data (MID) contains an MAC address DA encrypted under a predetermined rule from MAC address (MD) or the MAC address (MD) per se of the LAN card (7).
